(19) United States
(12) Patent Application Publication
(10) Pub. No.: US 2010/0129550 A1
(43) Pub. Date: May 27, 2010

(54) MODIFIED PIGMENTS

(76) Inventors: John D. Goddard, Dorset (GB); Alan R. Pitt, Hertfordshire (GB); Elizabeth A. Simister, Hertfordshire (GB); Mark Bradley, Edinburgh (GB); Anais F. Ronot, Chatou (FR)

Correspondence Address: EASTMAN KODAK COMPANY;PATENT LEGAL STAFF, 343 STATE STREET, ROCHESTER, NY, 14650-2201, US

(21) Appl. No.: 11/815,498

(22) PCT Filed: Dec. 22, 2005
(86) PCT No.: PCT/GB05/04997

§ 371 Date: Apr. 14, 2008

(30) Foreign Application Priority Data
Feb. 3, 2005 (GB) 0502216.5
Jul. 21, 2005 (GB) 0514969.5

(51) Int. Cl. B05D 5/00; C08F 2/46; C08F 20/56; C08F 120/06; C08F 120/10; C09D 11/10

(52) U.S. Cl. 427/256; 522/1; 522/104; 522/152; 522/153; 522/154; 525/329.4; 525/330.3; 525/329.5; 524/555; 524/560; 524/558

(57) ABSTRACT

Pigments for inkjet inks are controllably functionalised to improve water-dispersibility, ozone resistance, etc., by irradiation of the pigment particle with high energy radiation, such as gamma radiation in air or by plasma activation, to form a stable functionalisable intermediate pigment particle, then activating the stable functionalisable intermediate, e.g. by heating, in the presence of a functionalising precursor (e.g. a polymer or polymerisable monomer) to form a modified pigment particle having one or more functionalising group grafted onto the pigment particle.

### FIELD OF THE INVENTION

The present invention relates to a method of functionalising pigment particles, especially by covalent modification, to introduce beneficial properties to the pigment particles, for using them in, for example, inkjet inks. The invention further relates to pigments formed thereby, to ink formulations containing such functionalised pigments and to a method of printing using such ink formulations.

### BACKGROUND OF THE INVENTION

Aqueous inkjet ink formulations, which comprise pigment particles dispersed in an aqueous medium, typically offer several advantages over alternative water-soluble dye-based inks. For example, whilst dye-based inks may be utilised on porous or non-porous receivers, when they are used on fast-dry porous receivers, they are often susceptible to colour fade on prolonged exposure to light and ozone instability, whereas pigmented inks tend to have much reduced apparent colour fade over time. However, inkjet prints formed using such pigmented ink formulations do actually suffer from instability of the pigments to ozone and colour fade on prolonged exposure to light, although it is less apparent than in many dye-based inks.

A particular disadvantage of using inks comprising pigment particles as opposed to dye-based inks is that pigment particles are very poor at forming stable solutions or dispersions in aqueous media. Due to the insoluble nature of pigment particles in water, it is usually necessary to incorporate a surfactant into the ink formulation to stabilize the pigment dispersion.

It is known to graft organic groups, which contain specific surface groups such as phenols and carboxyl groups, onto the surface of carbon black particles, in order to provide improved properties.

U.S. Pat. No. 5,851,280 discloses a method of attaching organic groups onto pigments via reaction of a diazonium salt of the said organic groups with a pigment, to form modified pigments that can be used in a variety of applications, such as inks, inkjet inks, coatings, toners, plastics, rubbers and the like. The organic groups may have ionic or ionisable groups, the more of which organic groups, the better the water-dispersibility of the carbon black.

US-A-2002/0005146 describes a method of making a modified pigment for use in inkjet inks, the use of which modified pigments affords printed images that are notably more water-fast, highlighter smear-fast and smudge-resistant, than images formed using conventional pigmented inks. The method can be used to introduce modifications to carbon black or to coloured pigments. The method described involves attaching at least one chemical group onto the surface of a pigment particle and reacting the group with a second chemical group to form a third chemical group attached to the pigment, which first and second chemical groups contain at least one nucleophile and at least one electrophile respectively, or vice versa. The modified pigment described in US-A-2002/0005146 may comprise the reaction product of at least one (2-sulfatoethyl)sulfone group or at least one benzoic acid group with at least one nucleophilic polymer, or the reaction product of at least one electrophile, at least one nucleophilic polymer and an acylating agent to form covalently bonded modified pigment particles.

Chen et al describe in Polymer Journal (Tokyo, Japan), 34(1), 30-35 (2002) the radiation grafting of polyethylene onto carbon black by exposing polyethylene-adsorbed carbon black to gamma-ray irradiation. Short-lived polyethylene derived radicals generated by the gamma radiation are said to be trapped by carbon black to form polyethylene grafted carbon black. Greater than 90% of the adsorbed polyethylene was found to have grafted onto the carbon black when irradiated at an irradiation temperature near or above the melting point of polyethylene and at a dose of 200 kGy. The polyethylene grafted carbon black was said to have application as a novel gas sensor.

The method of introducing functionality onto carbon black in order to improve water dispersibility and other properties beneficial to inkjet printing with carbon black typically involves unattractive and inefficient syntheses via unstable diazonium intermediates. Furthermore, the range of functionality that can be introduced is limited to those materials capable of forming diazonium salts.

It would be desirable to provide a facile method of providing pigments with functionalisation to overcome the various disadvantages typically encountered when using pigments in their various applications.

### Problem to be Solved by the Invention

It is therefore an object of the present invention to provide a method by which a range of functionality can be introduced to a pigment by covalently attaching one or more pendant groups to the pigment in a controlled manner. It is a particular object to provide a method of introducing functionalities beneficial to inkjet printing with pigmented inks to improve, for example, the water dispersibility of the pigment to improve the ink formulation, and the ozone stability and light sensitivity of the pigment to improve image stability.

It is a further object of the invention to provide a stable intermediate pigment material capable of a pre-determined degree of functionality whereby a beneficial property can be introduced to a desired degree in a controlled manner.

The present inventors have found that by treating pigment particles with high energy radiation, e.g. gamma radiation or plasma activation, a stable intermediate may be formed which may be easily functionalised in a controlled manner to introduce one or more beneficial properties to the pigment particles.

### Summary of the Invention

According to a first aspect of the present invention, therefore, there is provided a method of functionalising a pigment particle, said method comprising treating a pigment particle by subjecting it to high energy radiation to form a stable functionalisable intermediate, subjecting said stable functionalisable intermediate to at least one activating treatment capable of activating said stable functionalisable intermediate to form an activated functionalisable intermediate and contacting said activated functionalisable intermediate with at least one functionalising precursor, whereby a functionalised pigment is formed, which comprises a pigment particle having one or more functionalising groups attached thereto.

According to a second aspect of the invention, there is provided a stable functionalisable intermediate pigment particle as defined above.

According to a third aspect of the invention, there is provided a method of preparing a stable functionalisable intermediate pigment particle comprising subjecting a pigment particle to gamma radiation in the presence of oxygen.

According to a fourth aspect, there is provided a functionalised pigment particle obtainable by the above method.

According to a fifth aspect, there is provided a functionalised pigment particle comprising a pigment particle having bound covalently thereto at least two different functionalising groups, each capable of imparting one or more functional features to said pigment particle, said at least two functionalising groups being arranged as two first order functionalising groups and/or as a first order functionalising group and a second order functionalising group.

According to a sixth aspect, there is provided an ink composition for inkjet printing comprising an aqueous solution/dispersion of one or more pluralities of pigment particles as defined above.

According to a seventh aspect, there is provided a method of ink-jet printing comprising the steps of providing an inkjet printer responsive to digital data signals, providing an inkjet receiver suitable for receiving pigmented inks, providing an ink composition as defined above to the inkjet printer and causing the inkjet printer to print according to a desired image.

According to an eighth aspect, there is provided a printed receiver obtainable by the above method of printing.

### ADVANTAGEOUS EFFECT OF THE INVENTION

The method of the present invention enables the formation of pigmented printing inks, which have one or more beneficial properties as desired. In particular, the method is capable of providing pigment particles which are self-dispersing, more resistant to ozone-related colour fade and/or capable of being further functionalised as desired. According to the invention, a range of functionality can be introduced to a pigment by covalently attaching one or more pendant groups to the pigment in a controlled manner, either serially, in parallel or both. Furthermore, the method of the invention may provide a stable intermediate pigment particle capable of a predetermined degree of functionality, whereby one or more beneficial properties can be introduced in a controlled manner by activating the stable functionalisable intermediate as appropriate and desired. A still further advantage is that the treatment of the pigment by subjecting it to high energy irradiation, such as gamma radiation or plasma treatment, provides a clean and convenient method of functionalisation that avoids the difficult and unpleasant chemistries typically associated with pigment functionalisation. The method of the invention is particularly applicable to the functionalisation of pigment particles for use in an inkjet ink.

### BRIEF DESCRIPTION OF THE DRAWINGS

FIG. 1 shows a graph of mass recovered (g) against concentration of monomer (% volume) to illustrate the effect of varying the concentration of a monomer on the degree of modification of a pigment by the resulting polymer.

FIG. 2 shows a graph of density remaining versus initial density of an unmodified Pigment Red 122 (represented by triangles) and two modified Pigment Red 122 (represented by diamonds and squares) after exposure to ozone for 1 week at 5 ppm.

### DETAILED DESCRIPTION OF THE INVENTION

The method of the present invention facilitates functionalisation of pigment particles in order to provide one or more beneficial properties to the pigment particles. The method enables a flexible approach to the introduction of pigment functionality, without the undesirable chemistry associated with previously known methods of introducing functionality into pigment particles.

According to the method of the invention, the pigment particle is functionalised by first forming an intermediate, which is stable and capable of being functionalised upon activation.

The stable functionalisable intermediate may be formed by subjecting a pigment particle to any treatment capable of forming a stable functionalisable intermediate pigment material. For example, the pigment particle may be irradiated with high energy radiation, e.g. with gamma radiation, in the presence of one or more reactive species, such as gaseous oxygen and/or sulfur or may be subjected to treatment with a plasma composition, to form a stable functionalisable intermediate having a plurality of functionalisable centres capable of being activated. Preferably, the pigment particle is irradiated with gamma radiation in the presence of oxygen.

Preferably, the irradiation of the pigment particle is not carried out at elevated temperatures, in order to discourage activation and reaction of the functionalisable intermediate. Preferably, the pigment particles are irradiated at a temperature of 100° C. or less, more preferably 80° C. or less and still more preferably 50° C. or less. In order to enable a clean reaction in the formation of the stable functionalisable intermediate, especially when irradiating with gamma radiation in the presence of oxygen, it is preferred that treatment of the pigment particle is carried out in the absence of any component likely to cause a competing reaction. In particular, where the stable functionalisable intermediate is prepared by irradiation of the pigment particle with gamma radiation in the presence of, for example, oxygen, it is preferred that a sample containing the pigment particle for irradiation consists essentially of pigment particles. Preferably, the environment in which the irradiation is carried out is air or an oxygen-rich environment, which more preferably is substantially free of components competing for reaction with the pigment particle.

The number of functionalisable centres on the stable functionalisable intermediate is preferably a function of the total radiation dose and/or the duration of irradiation and/or the concentration of the reactive species, such as oxygen or sulfur, present. The stable functionalisable intermediate formed preferably comprises the pigment particle having one or more pendant groups, capable of reacting, upon one or more further treatments, with a functionalising precursor to introduce a functionalising group onto the pigment particle. The pendant group (or functionalising centre) may be, for example, one or more of oxygen, dioxygen-containing groups (e.g. peroxide), sulfur or disulfide-containing groups. Optionally, where more than one type of pendant group or functionalising centre is formed on the stable functionalisable intermediate, at least two of said pendant groups or functionalising centres may be capable of reacting, optionally as a consequence of being reactive under different further treatments, with two or more different functionalising precursors to introduce two or more functionalising groups onto the pigment particle.

Such parallel functionalisation enables greater control of the degree to which it is intended to introduce two different functionalities than by, for example, simply relying on stoichiometric quantities of various functionalisable precursors, particularly if preparing two polymer groups using different monomers. It further allows a single batch of functionalisable pigment particle to be prepared, which can be functionalised to different degrees as desired rather than having to prepare a different functionalisable pigment for each desired use.

Alternatively, as mentioned above, the stable functionalisable intermediate may be formed by subjecting a pigment to treatment with a plasma composition, typically in a plasma generating system. A suitable plasma generating system is, for example, the Junior Plasma System available from Europlasma NV, and comprises a 2.45 GHz generator and a vacuum chamber. A plasma composition is a high energy, partially ionised gas or mixture of gases. The plasma composition may vary depending upon the gases from which it is formed, the relative proportions thereof and the duration and wavelength of irradiation (typically radiofrequency irradiation) utilised in forming the plasma composition. Gases or mixtures of gases that may be used in generating a plasma composition with which to treat a pigment to enable functional modification in accordance with the method of the invention include, for example, one or more of air, nitrogen, argon, oxygen, nitrous oxide, helium, tetrafluoromethane, water vapour, carbon dioxide, methane and ammonia. Preferably, in order to form a stable functionalisable intermediate, the plasma composition is generated from a mixture of oxygen and nitrogen. A plasma treatment may also be utilised to form the activated functionalisable intermediate, either directly from the pigment or by activation of the stable functionalisable intermediate and a plasma composition and source gas mixture may be selected accordingly. The number of functionalisable centres formed by plasma treatment of a pigment may be controlled by the duration of the treatment, the energy of the plasma-forming irradiation and, most importantly, by appropriate selection of the gases used to form the plasma composition. The choice of gases and relative proportions thereof used to form the plasma composition may also be used to control the reactivity of functionalisable centres formed to different monomer groups.

The present invention can be utilised to introduce one or more beneficial properties to a pigment particle by way of functionalisation. Beneficial properties that may usefully be introduced include, by way of example, improved water dispersibility, improved resistance to ozone-induced degradation, improved light stability, improved ability to fix in a receiving layer and improved humectant compatibility.

Improved humectant compatibility may be useful to enhance the stability of the pigment particle in a water/humectant mixture and may be achieved, for example, by functionalising the pigment with an ethylene oxide oligomer.

A pigment particle may be modified by the method of the present invention to improve the ability to fix in the receiving layer, or to improve mordancy of the pigment particle. For example, the pigment particle may be functionalised with a group capable of giving the pigment a charge (e.g. a negative charge), so that it can interact with positively charged particles in a porous receiver, or where the receiver comprises negatively charged particles, to give the pigment particle a positive charge.

Where two or more functionalising groups are to be introduced (e.g. to provide two or more beneficial properties to the pigment), they may be introduced in parallel or in series. By functionalising in parallel, it is meant that two or more functional groups are introduced e.g. directly to the activated pigment, or in other words, as first order functionalisation. By functionalisation in series, it is meant that a second functional group is added to a functional group attached to or closer to the pigment itself. The second functional group in this case may be considered to be a second order functionalisation, if it is added to a functional group attached directly to the pigment particle.

This enables different functionalities to be introduced in series or in parallel. For example, a pigment may be functionalised in parallel with several first order functionalising groups.

The one or more functionalising groups formed on the pigment particle may be any group capable of reacting with an activated pigment particle or a portion of a functionalising group already formed on the pigment particle and which is capable of providing a beneficial property to the pigment particle. The functionalising group may take any form, such as a small molecule or non-polymerisable monomer, oligomers and polymers formed by reaction of the activated functionalisable pigment particle with the reactive oligomer or polymer or with a monomer to form the oligomer or polymer on the particle, reactive moieties (e.g. pendant to a polymer group) capable of reacting with other species, and complexed metals complexed, for example, by ligands on one or more polymer groups or small molecule functionalising groups, among others.

The method of the invention typically enables covalent first-order modification of the pigment particle and optionally further covalent or non-covalent functionalisation.

Where the functionalising group is a polymer, two or more properties can be provided by carrying out a polymerisation reaction onto the functionalisable pigment particle with two or more monomers. The monomers may be added as a stoichiometric mixture of monomers, to form mixed copolymers providing a mixed beneficial property or may be added one monomer type at a time in order to form a block copolymer having a block corresponding to the first monomer providing a first property and a second block, in series, formed from the second monomer and providing a second property to the pigment particle.

Any suitable pigment may be functionalised according to the invention. Ideally, it should be capable of forming a stable functionalisable intermediate. Preferably, the pigment is capable of forming a stable functionalisable intermediate on treatment with gamma radiation in the presence of oxygen.

Pigment particles that may be functionalised according to the invention may be black pigments, magenta pigments, cyan pigments, yellow pigments, blue pigments, brown pigments, white pigments, violet pigments and red pigments, and any others.

Representative examples of black pigments include various carbon blacks (Pigment Black 7) such as channel blacks, furnace blacks and lamp blacks, and include for example, carbon blacks sold under the Regal®, Black Pearls®, Elftex®, Morarch®, Mogul® and Vulcan® trade marks available from Cabot Corporation. Other suitable carbon blacks include those available under the Printex™ and Special Black™ trade marks, available from Degussa Corporation, under the Raven™ trade mark (available from Columbian Chemical Corporation), and MA100 and MA400 available from Mitsubishi Chemical Corporation.

The coloured pigment may have a wide range of BET surface areas as measured by nitrogen absorption, but preferably the coloured pigment has a surface area equal to or greater than 85 m²/g and more preferably equal to or greater than about 100 m²/g, thereby corresponding to a smaller particle size. If a higher surface area pigment is not readily available, it is well recognised by those skilled in the art that the pigment may be subjected to conventional size reduction techniques, such as ball or jet milling, to reduce the pigment particle to the desired particle size.

Suitable classes of coloured pigments include, for example, anthraquinones, phthalocyanine blues, phthalocyanine greens, diazos, monoazos, pyranthones, perylenes, heterocyclic yellows, quinacridones and (thio)indigoids. Representative examples of phthalocyanine blues include copper phthalocyanine blue and derivatives thereof (Pigment Blue 15). Representative examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19 and Pigment Violet 42. Representative examples of anthraquinones include Pigment Red 43, Pigment Red 194 (Perinone Red) and Pigment Red 216 (Pyranthrone Red). Representative examples of perylenes include Pigment Red 123 (Vermillion), Pigment Red 149 (Scarlet), Pigment Red 179 (Maroon), Pigment Red 190 (Red), Pigment Violet 19, Pigment Red 189 (Yellow Shade Red) and Pigment Red 224. Representative examples of thioindigoids include Pigment Red 86, Pigment Red 87, Pigment Red 88, Pigment Red 181, Pigment Red 198, Pigment Violet 36 and Pigment Violet 38. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 151, Pigment Yellow 117, Pigment Yellow 128 and Pigment Yellow 138. Such pigments are commercially available from a number of sources including BASF Corporation, Englehard Corporation and Sun Chemical Corporation. Examples of other suitable pigments are described in the Colour Index, 3^{rd} edition (The Society of Dyers and Colourists, 1982). The colour pigment can have a wide range of BET surface areas, as measured by nitrogen adsorption.

Besides pigments for use in printing processes, the present invention can be used to introduce modification into carbon materials such as carbon fibre, graphite fibre, graphite powder, carbon cloth, vitreous carbon product, activated carbon and the like.

Pigment particles useful in the method the invention may be any pigment particles useful in the preparation of pigmented inks, especially for use in inkjet printing. They may have a primary particle size, for example, in the range of from about 10 nm to about 500 nm, and preferably from about 10 nm to about 250 nm, and primary aggregate sizes in the general range of from about 50 nm to about 100 μm, preferably from about 50 nm to about 10 μm and still more preferably from about 75 nm to about 1 μm. The BET surface area of particles useful in the method of the invention can be any suitable surface area and preferably ranges from about 10 m²/g to about 2000 m²/g and more preferably from about 10 m²/g to about 1000 m²/g and still more preferably from about 50 m²/g to about 500 m²/g and the particle structure preferably ranges from about 10 cm³ per 100 g to about 1000 cm³ per 100 g, more preferably from about 50 to about 200 cm³ per 100 g.

In one embodiment of the invention, the pigment particle is modified first by irradiation of the pigment particle with gamma rays in the presence of air in order to provide a stable functionalisable intermediate having functionalisable centres thereon which may react with a functionalising group upon activation. The number of functionalisable centres present in the stable functionalisable intermediate corresponds to factors such as the intensity and duration of the radiation applied to the pigment particle and the concentration and reactivity of oxygen (or other component) present. The degree of functionalisation may thereby be controlled by controlling the number of functionalisable centres in the stable functionalisable intermediate as well as by other means.

The pigment particle is preferably subjected to gamma irradiation to a total dose of up to 500 kGy, more preferably up to 50 kGy and also preferably at least 1 kGy. Still more preferably, the total dose is from 2.5 to 25 kGy, especially from 5 to 10 kGy. In any case, the dose may be controlled in order to control the number of functionalising centres formed.

In another embodiment, the pigment particle is modified first by treatment of the pigment particle with a plasma composition in order to provide a stable functionalisable intermediate having functionalisable centres thereon, which may react with a functionalising group upon activation. The number of functionalisable centres present in the stable functionalisable intermediate corresponds to factors such as the energy and duration of the irradiation used to generate the plasma composition, and the gases and relative proportions thereof from which the plasma composition is formed.

The stable functionalisable intermediate may be activated by any suitable means. In the present embodiment, the functionalisable centres may be activated by heating in the presence of the functionalising precursor.

Preferably, according to the present embodiments, the functionalising precursor is a polymerisable monomer or monomers. The polymerisable monomer or monomers used may be capable of forming a polymer, which provides one or more beneficial property to the pigment particle. The polymer may, for example, impart water-dispersibility to the pigment, provide reactive centres for further functionality, make the particle more hydrophobic or water-resistant, or impart improved ozone stability to the pigment particle.

Some examples of polymerisable monomers that may be used in accordance with this and other embodiments of the invention are provided in Table 1, with their Structures below. Further examples of suitable monomers are set out in Table 13 in the Examples.

TABLE 1
Polymerisable monomers useful as functionalising precursors

| Acronym | Chemical Name | Formula |
|---|---|---|
| | acrylamide | C₃H₅NO |
| | 2-acrylamido-2-methylpropane | C₇H₁₃NO |
| BMA | N-butyl methacrylate | C₈H₁₄O₂ |
| DMAA | N,N-dimethylacrylamide | C₅H₉NO |
| DMAEA | 2-dimethylamino ethyl acrylate | C₇H₁₃NO₂ |
| EMA | ethylmethacrylate | C₆H₁₀O₂ |
| | maleic anhydride | C₄H₂O₃ |
| | methyl acrylate | C₄H₆O₂ |
| | methacrylic acid | C₄H₆O₂ |
| HBMA | 2-Methyl-acrylic acid 4-hydroxy-butyl ester | C₈H₁₄O₃ |
| HEMA | 2-Methyl-acrylic acid 2-hydroxy-ethyl ester | C₆H₁₀O₃ |
| HPMA | 2-Methyl-acrylic acid 3-hydroxy-propyl ester | C₇H₁₂O₃ |
| MEMA | 2-Methyl-acrylic acid 2-methoxy-ethyl ester | C₇H₁₂O₃ |
| MMA | 2-Methyl-acrylic acid methyl ester | C₅H₈O₂ |
| MAA | methyl acrylamide | C₄H₇NO |
| | Polyvinylpyrrolidone | |
| St | styrene | C₈H₈ |
| | 4-vinylbenzylchloride | C₉H₉Cl |

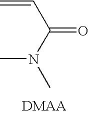

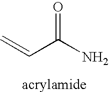

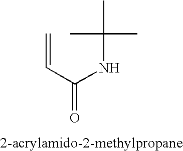

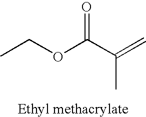

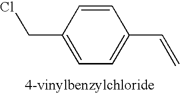

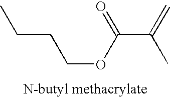

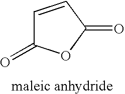

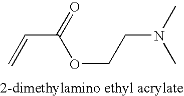

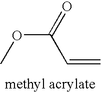

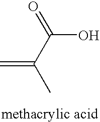

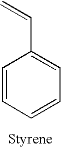

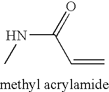

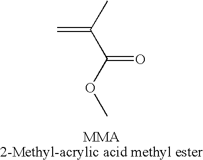

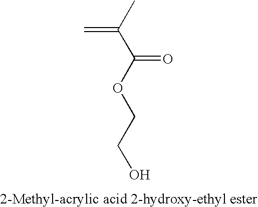

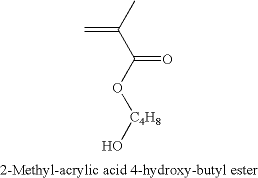

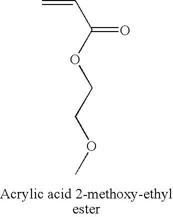

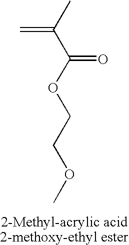

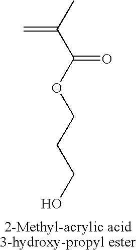

Preferably, in order to impart improved water-dispersibility, the pigment particle is functionalised with a polymer formed from one or more monomer carrying a water-solubilising group, especially DMAA.

In order to enable further functionalisation, monomers having readily reactive groups, such as 4-vinylbenzyl chloride, may be used as a functionalising precursor of, for example, a first order functionalising group, optionally to form a mixed copolymer (e.g. with a water-solubilising monomer), or a second order functionalising group. The resultant functionalisable group may then be further functionalised as desired.

In a preferred embodiment, a pigment particle (e.g. a magenta pigment particle) is modified to impart improved water-dispersibility and/or improved ozone-resistance. Preferably the pigment is modified to impart both improved water-dispersibility and improved ozone-resistance. This may be achieved, for example, by functionalising the pigment particle with functionalising groups carrying water-solubilising groups and functionalising groups having sacrificial or catalytic ozone-scavenging properties.

The two functionalising groups may be attached to the pigment particle according to the method of the invention as parallel first order functionalities, first and second order functionalities or jointly as a dual-property functionality (e.g. by forming a co-polymer from two monomers having respectively water-solubilising properties and ozone-scavenging properties).

Where the functionalising precursors used are polymerisable monomers, monomer(s) may be used which have the capability of imparting water-dispersibility and complexing an ozone scavenger such as manganese. The ozone scavenger, e.g. manganese, may then be introduced as a higher order functionality (e.g. second order).

According to another aspect and embodiment of the invention, a pigment particle may be functionalised with a functional group which has ozone-scavenging properties. The functional group may comprise a ligand and an ozone reactive metal ion or may comprise an organic ozone reactive moiety (both generally defined as an ozone scavenger—see below).

The ozone-scavenging functional group is introduced into the pigment particle by any suitable pigment grafting method, such as the pigment grafting techniques described in, for example, U.S. Pat. No. 5,851,280 and US-A-2002/0005146 among others, or by the method of the invention described above.

Where the ozone scavenger is a ligand and an ozone reactive metal ion which complexes with that ligand, it is preferred that the ligand is a moiety of a polymer covalently bound to the pigment particle, preferably by the method of the invention described above. The polymer may be a homopolymer, a mixed copolymer or a block copolymer, for example, and may have other beneficial properties such as water-dispersibility.

For example, a pigment such as Pigment Red 122 may be modified by forming a polymer thereon from a monomer such as the N-methacryloylamino-diacetic acid monomer below, which has water-solubilising groups capable of complexing with, for example, ozone-scavenging manganese ions. The modified pigment comprising the polymer (prepared, for example, by the method of the present invention) is then further modified by treatment with a solution of manganese salt and recovering the further modified pigment (second order modification with manganese ions). The resulting modified pigment will have improved dispersibility in water and better ozone stability.

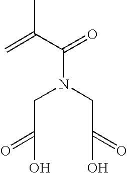

By ozone scavenger, it is meant any component that actively inhibits or prevents colour fade in printed images or in pigments caused by or accelerated by ozone, hydrogen peroxide, formaldehyde, nitrogen oxides (NOₓ), or other small gaseous molecules. It may be, for example, an ozone-specific scavenger, a hydrogen peroxide-specific scavenger or a formaldehyde-specific scavenger.

The ozone scavenger may be either a catalytic or sacrificial scavenger, but is preferably catalytic.

Suitable ozone scavengers that may be useful according to this aspect of the invention include, for example, complexes of metal ions of, for example, manganese, iron, zinc, aluminium and titanium, and organic ozone scavengers such as dithio octane diol (DTOD).

It is known in the art that several ozone-scavenging metal ions, such as manganese ions, for example, have a certain hue or colour associated with them. Attempting to improve the ozone stability of images formed on porous receivers by incorporating the coloured metal ions into the receiver is likely to result in a receiver (and corresponding image) having a background hue of that colour. A particular advantage of modified pigments according to the present aspect and embodiment of the invention, which modified pigments comprise one or more ozone scavenger associated therewith, is that since the potentially coloured ozone scavenger (e.g. metal ion) is associated only with those pigment particles susceptible to ozone instability, the ozone scavenger is present in sufficient quantities and in the appropriate location on the image receiver after printing to protect the pigment particles from attack by ozone. And yet, the ozone scavenger is not present in those areas of a printed image having little or no colour and so the problem of a background hue in the image receiver is overcome. The presence of the ozone scavengers at a particular location in the image is proportionate to the density of colour provided by the pigment particles at that location and consequently, any hue associated with the ozone scavenger is not apparent and the appropriate degree of ozone protection is provided.

Alternatively (or in addition), the ozone stability of the pigment particles can be enhanced, it has been found, through hindering the access to the pigment by ozone molecules through steric factors. In this regard, a protective barrier can be formed through covalent modification of the pigment in the manner of the invention as described above, such as by polymerisation of certain monomers onto the surface of a pigment particle. To provide an effective ozone stability improvement, it is preferable to modify the pigment with at least 25% by weight of polymer to pigment, more preferably at least 40% by weight and still more preferably from 50 to 60% by weight. Other beneficial properties can be provided by selecting the polymer such that, for example, water-dispersibility is improved. Thereby, covalent modification of pigment particles can provide water-dispersibility to a pigment by polymerisation on the particle of a monomer carrying water-soluble groups, which polymer provides a protective barrier by way of steric hindrance (and possibly an electronic effect, depending upon the functional groups on the polymer) to ozone. For example, a pigment such as Pigment Red 122 modified with an N,N-dimethylacrylamide polymer (e.g. to about 50% by weight of polymer to pigment) may show improved dispersibility in water and improved ozone stability.

As mentioned above, the size of particles used in the method of the invention may be controlled by conventional milling technologies prior to functionalisation. Alternatively, or additionally, the functionalised particles may be milled to the desired particle size after functionalisation, depending upon the type of formulation desired.

The modified pigments are formulated into inks by dispersing the optionally milled particles in an aqueous or non-aqueous vehicle, preferably an aqueous vehicle, optionally with or without the use of a dispersing aid, such as the surfactant potassium oleoyl methyl taurine (KOMT), depending upon whether the pigment has been modified to improve water-dispersibility. For pigments that have been modified to improve water-dispersibility, it is preferred that a dispersing aid is not used, or is present in only minimal quantities.

Optionally, the ink may be formulated with a humectant and an additional surfactant, such as Surfonyl® 465 (available from Air Products and Chemicals, Inc.) as a jetting aid/wetting aid (e.g. to aid jetting of the ink and wetting of the media).

Preferably, for inkjet printing, the vehicle is a water based vehicle comprising one or more of glycerol, diethylene glycol (DEG), diethylene glycol mono-butyl ether (DEGMBE) and other ethylene glycol derivatives, which act as humectants.

The invention will now be illustrated, without limitation, by the following Examples.

### EXAMPLES

### Example 1

### Irradiation of Pigment Red 122 (PR122)

Samples of 1.0 g Pigment Red 122 (Clariant Ink-jet Magenta E 02 VP 261; particle size: 89 nm) were irradiated in air in a Cobalt⁶⁰ gamma radiation source to give total doses of 2.5 kGy, 5 kGy and 10 kGy. The samples were then stored at −20° C. until required.

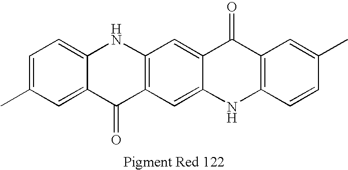

### Example 2

### Covalent Modification of Pigment Red 122

Each of the samples of the irradiated Pigment Red 122 (0.036 g) from Example 1 were placed in a glass vessel with N,N-dimethylacrylamide (1 ml) and N,N-dimethylformamide (3 ml). The mixture was degassed by bubbling through nitrogen and was then heated for 7 h at 120° C. After cooling, the mixture was added to cyclohexane/diethyl ether (1:1) (40 ml). The solvent was decanted, the precipitate washed with the mixture of cyclohexane and diethyl ether (2×40 ml) and the solid dried under vacuum. The product was purified by extraction in a Soxhlet apparatus with a mixture of cyclohexane/diethyl ether (1:1) and then dried to constant weight at 40° C. under vacuum.

Table 2 shows the reaction data and results for modified pigments A-J prepared by this method using activated pigment particles from Example 1 and various amounts of monomer. % grafting is calculated as:

% grafting=(mass_{modified pigment}−mass_{activated pigment})/mass_{activated pigment}

TABLE 2

| | Activated | DMF | DMAA | [monomer] | % |
|---|---|---|---|---|---|
| | Pigment mg | ml | ml | % vol | Grafting |
| A | 36 | 3 | 0.16 | 5 | 3244 |
| B | 36 | 3 | 1 | 25 | 3949 |
| C | 36 | 3 | 5.6 | 65 | 9619 |
| D | 5.6 | 3 | 0.16 | 5 | 675 |
| E | 19 | 3 | 0.53 | 15 | 1994 |
| F | 36 | 3 | 1 | 25 | 2080 |
| G | 56 | 3 | 1.6 | 35 | 2110 |
| H | 89 | 3 | 2.45 | 45 | 2068 |
| I | 130 | 3 | 3.7 | 55 | 1836 |
| J | 200 | 3 | 5.6 | 65 | 1513 |

### Example 3

### Irradiation of Carbon Black

Samples of 1.0 g Carbon Black (Degussa NIPex 160 IQ; particle size: 20 nm) were irradiated in air in a Cobalt⁶⁰ gamma radiation source to give total doses of 2.5 kGy. The samples were then kept at −20° C. until required.

### Example 4

### Covalent Modification of the Carbon Black

A sample of the irradiated carbon black (0.036 g) from Example 3 was placed in a glass vessel with styrene (1.0 ml) and N,N-dimethylformamide (3.0 ml). The mixture was degassed by bubbling through nitrogen and was then heated at 120° C. for 7 h. After cooling, the mixture was added to hexane (40 ml). The resulting precipitate was washed with hexane (2×40 ml), filtered and dried under vacuum to constant weight.

### Example 5

### Characterisation and Analysis of Modified Pigments

Various techniques for characterising and analysing the stable functionalisable intermediates prepared by Examples 1 and 3 and the modified pigment particles prepared by Examples 2 and 4 were carried out as discussed below.

### Identification of Radicals by EPR

An electron paramagnetic resonance (EPR) apparatus was used to confirm radical formation during irradiation. EPR of the Irradiated Pigment Red 122 of Example 1 (and of irradiated pigments in subsequent examples) confirmed the presence of oxygen radicals formed during the irradiation process.

### NMR

NMR spectra were carried out using CDCl₃ as the solvent. For all grafted pigments, NMR spectra confirmed the presence of polymers.

### MS

The EI and NH₃ DCl mass spectra of the DMAA modified pigment from Example 2 showed ions associated with polymerised dimethyl acrylamide (ions every 99 mass units), and an ion at ink 340 in EI mode for residual Pigment Red 122.

### Filtration

An experiment was performed to confirm that the polymers were fully grafted onto the pigment in the modified pigment formed according to Example 2. Pigment Red 122, irradiated Pigment Red 122 and a water-soluble grafted pigment e.g. Pigment Red 122 onto which DMAA had been grafted, (50 mg of each) were mixed and added to water and sonicated. Filtration of the mixture gave complete recovery of the Pigment Red 122 and the irradiated Pigment Red 122 since these were not soluble in water (<0.1 mg/ml for each), whereas the grafted pigment was completely soluble in water.

### Dialysis (Microcon Centrifugal Filter Devices, 3,000 Nominal Molecular Weight Limit)

A solution of one of the pigments grafted with polymer (e.g. Pigment Red 122 grafted with N,N-dimethylacrylamide) in water (0.3 g/l) was poured onto a Microcon filter. After centrifugation, a colourless solution was recovered and a magenta solid was found in the filter, which re-dissolved upon the addition of water, indicating that the pigment system had a molecular weight >3000.

Contact angle [1]

“Contact angle” is a concept used to measure the hydrophilicity of a grafted polymer. In the method used, the contact angle of a water droplet on polymer surface is determined from the relationship between contact angle and spreading area (a decrease in contact angle is associated with an increase in the area of the droplet).

The water with dye is dropped on the polymer film, which is prepared by spin coating, with robotic system. The picture of the droplet is taken by web cam from the top. The spreading area could then be automatically calculated by the image processing software Image Pro Plus.

Cover glasses were cleaned with chromic acid, washed with water and stored in THF before being spin coated (Spin coater P6700, Speedlines Technology) with the grafted polymer solution (20 mg/ml in THF). The cover glasses were dried overnight under vacuum before use.

Grafted polymers used were prepared before following the methods previously described.

Polymer coated cover glasses were placed on the base of a liquid handler (Multiprobe IIx, Packard). On the dispenser arm of the liquid handler a webcam (Quickcam, Logitech, 640×480 pixels) was mounted, so images could be taken vertically of the droplet. The liquid handler was programmed to dispense one droplet of 9 μl of water on each film, with a 20 second interval between each film. The dispensing volume of 9 μl was chosen arbitrarily in order to have a droplet of 3-4 mm in diameter, and this was duplicated. In all cases, 2 cover glasses coated with the same polymer were prepared to duplicate the results and check reproducibility. Once the photos were recorded, they were reprocessed automatically using the image processing software Image Pro Plus™ (Media Cybernatics).

Contact angle measurements (see Table 3) clearly show that the greater DMAA monomer concentration the more the contact angle decreases, therefore the DMAA grafted polymer becomes hydrophilic. It also shows that grafted styrene onto carbon black is slightly hydrophobic.

TABLE 3

| Polymer | Surface area (mm²) |
|---|---|
| Polystyrene | 8 |
| PHEMA | 14 |
| styrene grafted onto carbon black (1%) | 12 |
| DMAA/MAA (3/2) grafted onto PR122 (25%) | 39 |
| DMAA grafted onto PR122 (5%) | 49 |
| DMAA grafted onto PR122 (15%) | 34 |
| DMAA grafted onto PR122 (25%) | 32 |
| DMAA grafted onto PR122 (35%) | 31 |
| DMAA grafted onto PR122 (55%) | 28 |
| DMAA grafted onto PR122 (65%) | 27 |

### Example 6

### Cross-Linking Experiments

In order to examine the effect of the order of addition of a monomer and a cross-linker, a series of three experiments (Examples 6, 7 and 8) were carried out, in which respectively the cross-linker and monomer were added together, monomer first and cross-linker first. In this experiment, a series of solutions of activated Pigment Red 122 (36 mg; irradiated in air in a Cobalt⁶⁰ gamma radiation source to a total dose of 25 kGy), dimethylacrylamide (1 ml) and a specific volume (varied—see Table 4) of the cross-linking ethylene glycol dimethacrylate in DMF (3 ml) were degassed by bubbling with oxygen free nitrogen for 2 h and then heated for 7 h at 120° C. After cooling, the mixtures were added to 40 ml of a mixture of cyclohexane and ether (cyclohexane:ether ratio 1:1). The precipitates were washed with cyclohexane:ether (1:1; 2×40 ml) and were dried under vacuum. The graft weight percentages for the respective volumes of cross-linking agent used are presented in Table 4

TABLE 4

| Volume of ethylene glycol | |
|---|---|
| dimethacrylate (ml) | Graft weight % |
| 0.2 | 1355 |
| 0.4 | 4116 |
| 0.6 | 4761 |
| 0.8 | 5316 |
| 1 | 7400 |

As can be seen from Table 4, increasing the amount of cross-linking agent at the start of the experiment increases the incorporation of cross-linking monomer leading to a greater % graft weight. From visual inspection of the modified pigments formed, it was clear that a good deal of cross-linking had also occurred and that purification would be difficult.

### Example 7

### Cross-Linking Experiments

A series of solutions of activated Pigment Red 122 (36 mg; irradiated in air in a Cobalt⁶⁰ gamma radiation source to a total dose of 25 kGy) and dimethylacrylamide (1 ml) in DMF (3 ml) were degassed by bubbling with oxygen free nitrogen for 2 h and then heated for 5 h at 120° C. A specific volume (varied—see Table 5) of the cross-linking ethylene glycol dimethacrylate was then added to each solution and the solutions heated for 7 h at 120° C. After cooling, the mixtures were added to 40 ml of a mixture of cyclohexane and ether (cyclohexane:ether ratio 1:1). The precipitates were washed with cyclohexane:ether (1:1; 2×40 ml) and dried under vacuum. The graft weight percentages for the respective volumes of cross-linking agent used are presented in Table 5.

TABLE 5

| Volume ethylene glycol | |
|---|---|
| dimethacrylate (ml) | Graft weight % |
| 0.01 | 2522 |
| 0.05 | 2733 |
| 0.1 | 4642 |
| 0.5 | 3455 |
| 1 | 4678 |

Increasing the volume of cross-linker in this experiment led to increased cross-linking (as evidenced by the increased graft weight %), but would not lead to significant polymerisation of the cross-linking monomer onto the pigment since it was added at a later stage in the experiment, when most of the functionalisable sites will have been occupied by monomer.

### Example 8

### Cross-Linking Experiments

A series of solutions of activated Pigment Red 122 (36 mg; irradiated in air in a Cobalt⁶⁰ gamma radiation source to a total dose of 25 kGy) and a specific volume (varied—see Table 6) of the cross-linking ethylene glycol dimethacrylate in DMF (3 ml) were degassed by bubbling with oxygen free nitrogen for 2 h and then heated for 5 h at 120° C. Dimethylacrylamide (1 ml) was then added to each solution and the mixtures heated for 7 h at 120° C. After cooling, the mixtures were added to 40 ml of a mixture of cyclohexane and ether (cyclohexane:ether ratio 1:1). The precipitates were washed with cyclohexane:ether (1:1; 2×40 ml) and dried under vacuum. The graft weight percentages for the respective volumes of cross-linking agent used are presented in Table 6.

TABLE 6

| Volume ethylene glycol | |
|---|---|
| dimethacrylate (ml) | Graft weight % |
| 0.01 | 2094 |
| 0.05 | 2516 |
| 0.1 | 4066 |
| 0.5 | 4344 |
| 1 | 6233 |

A significant increase in the graft weight % arose as a result of increasing the amount of cross-linker due to polymerisation of the cross-linker onto the pigment, as well as due to cross-linking.

### Example 9

### Cross-Linking Reactions on Carbon Black

A series of solutions of activated carbon black (36 mg; irradiated in air in a Cobalt⁶⁰ gamma radiation source to a total dose of 25 kGy), styrene (1 ml) and a specific volume (varied—see Table 7) of the cross-linking agent divinylbenzene in DMF (3 ml) were degassed by bubbling with oxygen free nitrogen. The mixtures were then heated for 7 h at 120° C. After cooling, the mixtures were added to 40 ml of a mixture of cyclohexane and ether (cyclohexane:ether ratio 1:1). The precipitates were washed with cyclohexane:ether (1:1; 2×40 ml) and dried under vacuum. The graft weight percentages for the respective volumes of cross-linking agent used are presented in Table 7.

TABLE 7

| Volume divinylbenzene (ml) | Graft weight % |
|---|---|
| 0.2 | 2650 |
| 0.4 | 3956 |
| 0.6 | 4150 |
| 0.8 | 5372 |
| 1 | 5456 |

### Example 10

A series of solutions of activated carbon black (36 mg; irradiated in air in a Cobalt⁶⁰ gamma radiation source to a total dose of 25 kGy) and styrene (1 ml) in DMF (3 ml) were degassed by bubbling with oxygen free nitrogen. The mixtures were then heated for 5 h at 120° C. A specific volume (varied—see Table 8) of the cross-linking agent divinylbenzene was added to each solution and the resulting mixtures heated for 7 h at 120° C. After cooling, the mixtures were added to 40 ml of a mixture of cyclohexane and ether (cyclohexane:ether ratio 1:1). The precipitates were washed with cyclohexane:ether (1:1; 2×40 ml) and dried under vacuum. The graft weight percentages for the respective volumes of cross-linking agent used are presented in Table 8.

TABLE 8

| Volume divinylbenzene (ml) | Graft weight % |
|---|---|
| 0.01 | 427 |
| 0.05 | 1355 |
| 0.1 | 3003 |
| 0.5 | 3419 |
| 1 | 2458 |

### Example 11

A series of solutions of activated carbon black (36 mg; irradiated in air in a Cobalt⁶⁰ gamma radiation source to a total dose of 25 kGy) and a specific volume (varied—see Table 9) of the cross-linking agent divinylbenzene in DMF (3 ml) were degassed by bubbling with oxygen free nitrogen. The mixtures were then heated for 5 h at 120° C. Styrene (1 ml) was added to each solution and the resulting mixtures heated for 7 h at 120° C. After cooling, the mixtures were added to 40 ml of a mixture of cyclohexane and ether (cyclohexane:ether ratio 1:1). The precipitates were washed with cyclohexane:ether (1:1; 2×40 ml) and dried under vacuum. The graft weight percentages for the respective volumes of cross-linking agent used are presented in Table 9.

TABLE 9

| Volume divinylbenzene (ml) | Graft weight % |
|---|---|
| 0.05 | 2050 |
| 0.1 | 2427 |
| 0.5 | 2797 |
| 1 | 4500 |

### Example 12

### Copolymerisation on Pigment Red

Samples of activated Pigment Red 122 (36 mg; irradiated in air in a Cobalt⁶⁰ gamma radiation source to a total dose of 25 kGy) were placed in glass vessels with 1 ml of each of Monomer A and Monomer B and 3 ml of DMF as solvent. The mixtures were degassed by bubbling with oxygen free nitrogen and then heated for 7 h at 120° C. After cooling, the mixtures were added to 40 ml of a mixture of cyclohexane and ether (cyclohexane:ether ratio 1:1). The precipitates were washed with cyclohexane:ether (1:1; 2×40 ml) and dried under vacuum until constant weight. Formation of copolymers on the pigment was observed. The data obtained for each respective pair of monomers used is presented in Table 10.

The monomers used were styrene, 2-methylacrylic acid 3-hydroxy propyl ester (HPMA), 2-methylacrylic acid 4-hydroxy butyl ester (HBMA) and 2-methylacrylic acid 2-hydroxy ethyl ester HEMA as Monomer A and 2-methyl acrylic acid methyl ester (MMA), N,N-dimethylacrylamide (DMAA), ethyl-methacrylate (EMA) and N-butyl methacrylate (BMA) as Monomer B.

TABLE 10

| Monomer A | Monomer B | Graft weight (%) |
|---|---|---|
| Styrene | DMAA | 2800 |
| Styrene | MMA | 2880 |
| HPMA | DMAA | 5100 |
| HPMA | MMA | 1940 |
| HPMA | EMA | 1500 |
| HPMA | BMA | 950 |
| HBMA | DMAA | 1990 |
| HBMA | MMA | 250 |
| HBMA | EMA | 1230 |
| HBMA | BMA | 950 |
| HEMA | DMAA | 4000 |
| HEMA | EMA | 272 |
| HEMA | BMA | 1090 |

### Example 13

### Copolymerisation on Pigment Red

Using different ratios of N,N-dimethylacrylamide and methylacrylamide, but in a combined molar concentration relative to activated Pigment Red 122 (36 mg; irradiated in air in a Cobalt⁶⁰ gamma radiation source to a total dose of 25 kGy) of 100:1, it was possible to control the solubility of the new grafted polymer in water (3 g/l). The more DMAA used, the more solubility increased.

Samples of activated Pigment Red 122 were placed in glass vessels with 1 ml of a mixture of monomers, 5 mg of Fe₂SO₄ and 3 ml of DMF as solvent. The mixtures were degassed by bubbling with oxygen free nitrogen and then heated for 7 h at 120° C. After cooling, the mixtures were added to 40 ml of a mixture of cyclohexane and ether (cyclohexane:ether ratio 1:1). The precipitates were washed with cyclohexane:ether (1:1; 2×40 ml) and dried under vacuum until constant weight. Formation of copolymers on the pigment was observed and the graft weight percent and relative proportions of monomers in each case are set out in Table 11.

TABLE 11

| Activated | DMAA | MAA | Fe₂SO₄ | DMF | Graft |
|---|---|---|---|---|---|
| Pigment (mg) | (ml) | (ml) | (mg) | (ml) | weight (%) |
| 36 | 1 | 0 | 5 | 3 | 3950 |
| 36 | 0.6 | 0.4 | 5 | 3 | 636 |

### Example 14

Samples of activated carbon black (36 mg; irradiated in air in a Cobalt⁶⁰ gamma radiation source to a total dose of 25 kGy) were placed in glass vessels with 1 ml of styrene, a variable amount of another monomer (see Table 12) and 3 ml of DMF as solvent. The mixtures were degassed by bubbling with oxygen free nitrogen for 2 h and then heated for 7 h at 120° C. After cooling, the mixtures were added to 40 ml of a mixture of cyclohexane and ether (cyclohexane:ether ratio 1:1). The precipitates were washed with cyclohexane:ether (1:1; 2×40 ml) and dried under vacuum until constant weight. The graft weight (%) is set out in Table 12 for each combination of monomers. The monomers used were selected from styrene, 2-methyl acrylic acid methyl ester (MMA), ethylmethacrylate (EMA) and N-butyl methacrylate.

TABLE 12

| V_{styrene} | V_{MMA} | V_{EMA} | V_{BMA} | |
|---|---|---|---|---|
| (ml) | (ml) | (ml) | (ml) | Graft weight (%) |
| 1 | 0 | 0 | 0 | 1666.7 |
| 1 | 0.2 | 0 | 0 | 2222 |
| 1 | 0.5 | 0 | 0 | 2722 |
| 1 | 1 | 0 | 0 | 4000 |
| 1 | 0 | 0.5 | 0 | 2566.67 |
| 1 | 0 | 1 | 0 | 2370 |
| 1 | 0 | 0 | 0.5 | 2848 |
| 1 | 0 | 0 | 1 | 2222 |

### Example 15

### Irradiation and Covalent Modification of Pigment Yellow 155

Samples of 1.0 g of Pigment Yellow 155 were irradiated in air in a Cobalt⁶⁰ gamma radiation source to give total doses of 50 kGy. The samples were then stored at −20° C. until required.

Each of the samples of the irradiated Pigment Yellow 155 were placed in a glass vessel with 100 molar equivalents of N,N-dimethylacrylamide (1 ml) as the monomer and DMF (3 ml) as solvent. The mixture was degassed by bubbling through nitrogen and was then heated for 7 h at 120° C. After cooling, the mixture was added to cyclohexane/diethyl ether (1:1) (40 ml). The precipitate was washed with the mixture of cyclohexane and diethyl ether (2×40 ml) and the solid dried under vacuum (% grafting=2594%).

### Example 16

### Irradiation and Covalent Modification of Pigment Blue B26

Samples of 1.0 g of Pigment Blue B26 were irradiated in air in a Cobalt⁶⁰ gamma radiation source to give total doses of 50 kGy. The samples were then stored at −20° C. until required.

Each of the samples of the irradiated Pigment Blue B26 were placed in a glass vessel with 100 molar equivalents of N,N-dimethylacrylamide (1 ml) as the monomer and DMF (3 ml) as solvent. The mixture was degassed by bubbling through nitrogen and was then heated for 7 h at 120° C. After cooling, the mixture was added to cyclohexane/diethyl ether (1:1) (40 ml). The precipitate was washed with the mixture of cyclohexane and diethyl ether (2×40 ml) and the solid dried under vacuum (% grafting=2730%).

### Example 17

Using the methods of Examples 2, 4, 15 and 16, polymer grafts were formed on Pigment Red 122 (PR 122), Carbon Black (CB), Pigment Yellow 155 (PY 155) and Pigment Blue 15:3 (PB 15:3), using the polymerisable monomers set out in Table 13 below, which shows the % grafting obtained in each case.

TABLE 13

| | | % | Contact |
|---|---|---|---|
| Monomers | Pigments | Grafting | Angle/mm² |
| Acrylamide | PR122 | 17 | 16.46 |
| | PY155 | 64 | 17.62 |
| | PB15:3 | 1 | 15.48 |
| | CB | 125 | 16.53 |
| 2-Acrylamido-2- | PR122 | 121 | 20.69 |
| methylpropane sulfonic | PY155 | 121 | 29.98 |
| acid | PB15:3 | 65 | 19.69 |
| | CB | 125 | 18.61 |
| BMA | PR122 | 88 | 12.47 |
| | PY155 | 300 | 10.99 |
| | PB15:3 | 121 | 14.373 |
| | CB | 533 | 13.25 |
| DMAA | PR122 | 2594 | 20.35 |
| | PY155 | 2594 | 26.91 |
| | PB15:3 | 2730 | 22.128 |
| | CB | 2427 | 22.31 |
| DPPH | PR122 | 38 | 12.92 |
| | PY155 | 613 | 15.21 |
| | PB15:3 | 2200 | 15.312 |
| | CB | 3767 | 11.78 |
| EMA | PR122 | 100 | 13.58 |
| | PY155 | 285 | 13.025 |
| | PB15:3 | 147 | 16.69 |
| | CB | 4500 | 12.63 |
| HBA | PR122 | 781 | 25.26 |
| | PY155 | 532 | 22.64 |
| | PB15:3 | 966 | 20.86 |
| | CB | 71 | 15.8 |
| HBMA | PR122 | 521 | 14.28 |
| | PY155 | 233 | 14.89 |
| | PB15:3 | 358 | 15.38 |
| | CB | 175 | 12.62 |
| HEA | PR122 | 58 | 17.98 |
| | PY155 | 774 | 16.56 |
| | PB15:3 | 164 | 20.8 |
| | CB | 77 | 17.83 |
| HEMA | PR122 | 4304 | 17.425 |
| | PY155 | 677 | |
| | PB15:3 | 2317 | |
| | CB | 83 | |
| HPMA | PR122 | 1109 | 16.08 |
| | PY155 | 833 | 16.65 |
| | PB15:3 | 955 | |
| | CB | 18 | |
| Maleic anhydride | PR122 | 70 | 17.18 |
| | PY155 | 64 | 21.185 |
| | PB15:3 | 51 | 17.21 |
| | CB | 42 | 26.15 |
| Methyl acrylate | PR122 | 1148 | 14.736 |
| | PY155 | 1000 | 13.243 |
| | PB15:3 | 439 | 13.18 |
| | CB | 3489 | 14.33 |
| Polyvinylalcohol | PR122 | 136 | 17.08 |
| | PY155 | 141 | 17.53 |
| | PB15:3 | 169 | 16.476 |
| | CB | 138 | |
| Styrene | PR122 | 291 | 13.65 |
| | PY155 | 258 | 15.57 |
| | PB15:3 | 248 | 15.71 |
| | CB | 1066 | 11.66 |
| 4-Vinyl-benzenesulfonic acid | PR122 | 77 | 17.535 |
| | PY155 | 102 | 21.313 |
| | PB15:3 | 92 | 19.79 |
| | CB | 105 | 18.35 |
| 4-Vinylbenzylchloride | PR122 | 411 | 10.93 |
| | PY155 | 205 | 11.88 |
| | PB15:3 | 269 | |
| | CB | 655 | 10.35 |

### Example 18

### Esterification of Modified Pigments

Several modified pigments having polymers covalently bound thereto, which were prepared by the method of the present invention (utilising gamma irradiation to form the stable functionalisable intermediate), were further modified to introduce an extra, optionally functional, group onto the modified pigment material by esterification. The modified pigments used were Pigment Red 122 modified with a polymer of hydroxybutyl acrylate (pHBA-PR122) and with a polymer of hydroxyethyl acrylate (pHEA-PR122), carbon black modified with a polymer of hydroxybutyl acrylate (pHBA-CB) and with a polymer of hydroxyethyl acrylate (pHEA-CB) and Pigment Yellow 155 modified with a polymer of hydroxyethyl acrylate (pHEA-PY155). Each of the modified pigments (in an amount shown in Table 14 below) was dissolved in THF (5 ml) and treated with triethylamine (1.3 ml) then 10-undecenoyl chloride (1 ml), which produced a precipitate. The mixture was sonicated and DMAP (0.28 g) was added. The solution was mixed at room temperature for 4 h. Methanol (10 ml) was then added dropwise. The solution was centrifuged and the resultant solid dried under vacuum.

The esterification of the modified pigments was confirmed by NMR studies and the % grafting and solubility in each case is set out in Table 14.

TABLE 14

| Modified | | | | |
|---|---|---|---|---|
| pigment | M (mg) | M resultant (mg) | Grafting % | Solubility |
| pHBA-PR122 | 30.9 | 33 | 6 | CDCl₃ |
| pHEA-PR122 | 19.5 | 26 | 33 | DMF |
| pHBA-CB | 30.8 | 32.7 | 6 | CDCl₃ |
| pHEA-CB | 31 | 34.5 | 11 | DMF |
| pHEA-PY155 | 37.9 | 44 | 16 | DMF |

### Example 19

### Effect of Monomer Concentration

A series of solutions of activated Pigment Red 122 (36 mg; irradiated in air in a Cobalt⁶⁰ gamma radiation source to a total dose of 25 kGy) were treated according to the method of Example 2 with various amounts of N,N-dimethylacrylamide ranging from 0 to 65% volume and the mass of modified pigment recovered was measured to illustrate the effect of varying the concentration of the monomer. The amount of monomer used and the mass of modified pigment recovered are set out in Table 15.

TABLE 15

| [M] % vol | Mass recovered (g) |
|---|---|
| 0 | 0 |
| 5 | 0.043 |
| 15 | 0.4 |
| 25 | 0.78 |
| 35 | 1.238 |
| 45 | 1.93 |
| 55 | 2.518 |
| 65 | 3.226 |

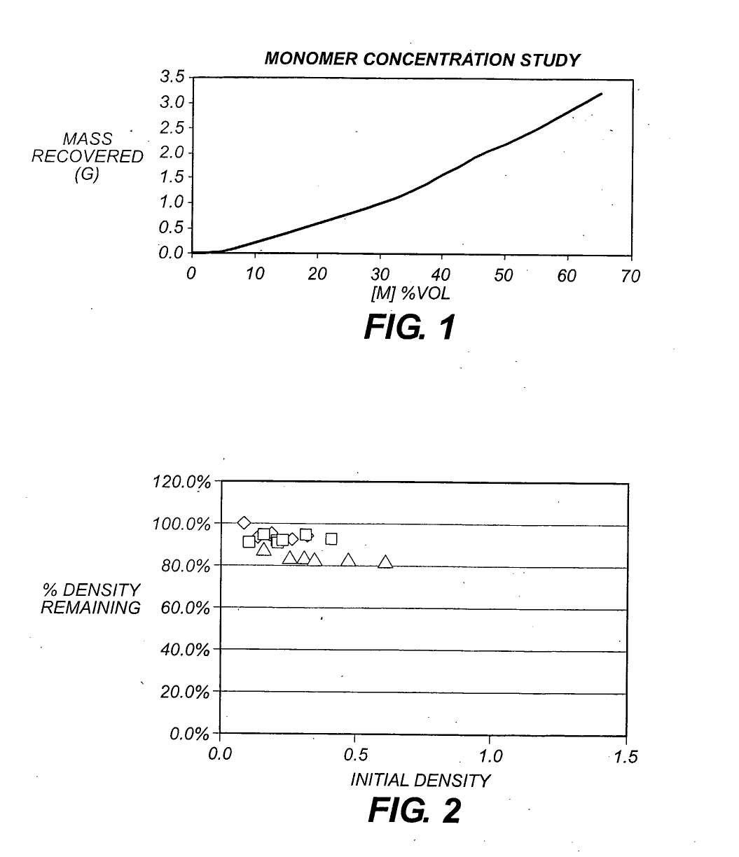

The results set out in Table 15 are presented in a graph in FIG. 1, which illustrates the approximately linear effect of increasing monomer concentration (up to 65% volume, at least). Therefore, the degree of an effect that is proportional to the amount of polymer present on the particle can be controlled by controlling the concentration of monomer used to modify the pigment.

### Example 20

### Plasma Activation

Using a Junior Plasma System, available from Europlasma NV, as a Plasma irradiation source (oxygen, nitrogen), samples of 1 g of Pigment Red 122, Carbon Black, Pigment Yellow 155 and Pigment Blue B26 were subjected to plasma irradiation. (During this stage, as an alternative procedure, various polymerisable monomers may be added to enable single step modification of the pigment without a separate pigment modification step). The resulting activated pigment samples were stored at −20° C. until required.

Each of the samples of the plasma activated Pigment Red 122, Carbon Black, Pigment Yellow 155 and Pigment Blue B26 were placed in a glass vessel with 100 molar equivalents of N,N-dimethylacrylamide (1 ml) as the monomer and DMF (3 ml) as solvent. The mixture was degassed by bubbling through nitrogen and was then heated for 7 h at 120° C. After cooling, the mixture was added to cyclohexane/diethyl ether (1:1) (40 ml). The precipitate was washed with the mixture of cyclohexane and diethyl ether (2×40 ml) and the solid dried under vacuum.

### Example 21

Ink formulations were prepared using modified pigments of the invention (DMAA-modified magenta pigment PR122) prepared as Samples A, B and H in Example 2 above and an unmodified control pigment (magenta pigment PR122—“Control”) in order to illustrate the beneficial performance of the modified pigment in an ink formulation.

A slurry of each of three pigments and of the control pigment was prepared by milling the pigment at the highest level possible (˜3% w/w) in water with no added dispersing aid and using the DC micro-mill (pigments are usually milled at approximately 10% w/w with the dispersant KOMT).

The DC micro-mill resembles a mini-attritor. A vertical stainless steel central shaft, with horizontal pegs spaced at regular intervals along the bottom third, is rotated in a 50 ml plastic tube, which contains the media, pigment and water, added in that order.

The slurries were prepared by milling at 1700 rpm for 90 min. at 25° C. (torque setting H65), using 44.8 g (˜19 ml) of zirconium silicate beads as media.

Each of pigments A, B and H and the control pigment were successfully milled and prepared into Inks A, B and H and control Ink.

Ink formulations were prepared using three modified pigments of the invention (Samples A-C) and the unmodified control. The inks were prepared using approximately 10% w/w glycerol, 10% w/w DEG, 8% w/w DEGMBE, 0.5-0.7% w/w Surfonyl 465 surfactant and 1% w/w of each of the pigment slurries prepared as set out above.

The intensity and hue of the colour obtained in the inks prepared with the modified pigments were slightly different from that obtained using the unmodified pigment as control. On keeping for 48 h, the unmodified pigment completely dropped out of solution, some settling was observed with Ink A and no settling was observed with Inks B and H.

Each of the inks were then placed in a disposable 3 ml plastic pipette (with tip cut off) and attached to the yellow nozzle of the ink jet head of an Epson 740 printer (after having purged with a pigment-free sample of the ink formulation to be used). A standard template was printed onto HP Premium Inkjet Glossy Paper on the photo paper print setting (1440 dpi) for each of the inks.

With the control ink, the printer head rapidly became blocked and stopped firing. In the case of each of Inks A, B and H, prepared with the modified pigments, a uniform print was obtained with no obvious blocking of the nozzles of the printer head.

The grafting of a DMAA derived polymer onto the pigment particles by the method of the present invention improves the water-dispersibility of the pigment particle and the stability of the ink over time.

### Example 22

### Ozone Stability

An experiment was conducted to compare the effect of exposure to ozone for 1 week at 5 ppm on inks containing unmodified control Pigment Red 122 and modified Pigment Red 122 grafted with (a) 15% w/w (b) 200% w/w N,N-dimethylacrylamide. The ink formulations were prepared as described in Example 21.

FIG. 2 shows that the inks containing modified pigments with (a) 15% grafted (represented by diamonds) and (b) 200% grafted (represented by squares), were more stable towards ozone than the control ink containing the unmodified pigment (represented by triangles), in that a significantly higher percentage of density remained after exposure for 1 week with both the modified pigments.

1. A method of functionalising a pigment particle, said method comprising the steps of treating a pigment particle by subjecting it to high energy radiation to form a stable functionalisable intermediate, subjecting said stable functionalisable intermediate to at least one activating treatment capable of activating said stable functionalisable intermediate to form an activated functionalisable intermediate and contacting said activated functionalisable intermediate with at least one functionalising precursor, whereby a functionalised pigment is formed, which comprises a pigment particle having one or more functionalising groups attached thereto, each of which functionalising groups are capable of providing a functional feature to the pigment particle.

2. A method as claimed in claim 1, wherein the stable functionalisable intermediate is formed by subjecting the pigment particle to γ-irradiation in the presence of oxygen.

3. A method as claimed in claim 1, wherein the stable functionalisable intermediate is formed by subjecting the pigment to plasma activation by a plasma composition.

4. (canceled)

5. A method as claimed in claim 1, wherein the at least one activating treatment comprises heating said stable functionalisable intermediate.

6. A method as claimed in claim 1, wherein the functionalised pigment particle comprises a first functionalising group capable of providing a functional feature to the pigment particle and a second functionalising group different from said first functionalising group and capable of providing a functional feature the same as or different from said first functional feature, said first and second functionalising groups functionalising the pigment particle in parallel.

7. A method as claimed in claim 1, wherein the functionalised pigment particle comprises a first functionalising group, which first functionalising group imparts improved water-dispersibility to the pigment particle.

8. A method as claimed in claim 1, wherein the functionalised pigment particle comprises a first functionalising group, which imparts improved water-dispersibility to the pigment particle, wherein said first functionalising group is a polymer comprising water-solubilising groups.

9. A method as claimed in claim 1, wherein at least one of said functionalising groups is a polymer comprising monomer units selected from one or more of acrylamide, 2-acrylamido-2-methylpropane, N-butyl methacrylate, N,N-dimethylacrylamide, 2-dimethylamino ethyl acrylate, ethylmethacrylate, maleic anhydride, methyl acrylate, methacrylic acid, 2-methyl acrylic acid 2 hydroxy ethyl ester, 2-methylacrylic acid 3 hydroxy propyl ester, 2-methyl acrylic acid 2 methoxy ethyl ester and methyl acrylamide.

10. A method as claimed in claim 1, wherein the functionalised pigment particle comprises a functionalising group, which imparts improved ozone resistance to the pigment particle.

11. A method as claimed in claim 1, wherein at least one of said functionalising groups comprises a catalytic ozone scavenger and/or a sacrificial ozone scavenger.

12. A method as claimed in claim 1, wherein a first functionalising group imparts improved water dispersibility to the pigment particle, and a second functionalising group imparts improved ozone resistance to the pigment particle.

13. (canceled)

14. A method as claimed in claim 1, which further comprises reacting said functionalised pigment particle with at least one functionalising precursor whereby a second order functionalised pigment is formed, which comprises a pigment particle having one or more first order functionalising groups attached thereto and one or more second order functionalising groups attached serially to said first order functionalising groups.

15. A method as claimed in claim 1, wherein said stable functionalisable intermediate comprises first functionalisable centres and second functionalisable centres, said first functionalisable centres being different to said second functionalisable centres by requiring different activation treatments to form respective activated functionalisable centres and/or by being reactive with different functionalisable precursors upon activation.

16-22. (canceled)

23. A functionalised pigment particle obtainable by the method of claim 1.

24. (canceled)

25. A functionalised pigment particle comprising a pigment particle having bound covalently thereto at least two different functionalising groups, each capable of imparting one or more functional features to said pigment particle, said at least two functionalising groups being arranged as two first order functionalising groups and/or as a first order functionalising group and a second order functionalising group, wherein said at least one or more functional features includes improved ozone-resistance.

26. (canceled)

27. A functionalised pigment particle as claimed in claim 25, wherein at least one of the at least two functionalising groups is a polymer comprising monomer units selected from one or more of acrylamide, 2-acrylamido-2-methylpropane, N-butyl methacrylate, N,N-dimethylacrylamide, 2-dimethylamino ethyl acrylate, ethylmethacrylate, maleic anhydride, methyl acrylate, methacrylic acid, 2-methyl acrylic acid 2 hydroxy ethyl ester, 2-methylacrylic acid 3 hydroxy propyl ester, 2-methyl acrylic acid 2 methoxy ethyl ester and methyl acrylamide.

28. (canceled)

29. A functionalised pigment particle as claimed in claim 25, which comprises a functional group which is an ozone scavenger.

30. A functionalised pigment particle as claimed in claim 25, which comprises a functional group which is an ozone scavenger and wherein the ozone scavenging functional group comprises at least one ligand and an ozone-reactive metal ion wherein the ozone-reactive metal ion is selected from the ions of metals in the group consisting of manganese, iron, zinc, aluminium and titanium.

31. (canceled)

32. A functionalised pigment particle as claimed in claim 30, wherein the ligand is a pendant group on a polymer.

33. An ink composition for inkjet printing comprising an aqueous solution/dispersion of one or more pluralities of pigment particles as defined in claim 23.

34. (canceled)

35. A method of inkjet printing comprising the steps of providing an inkjet printer responsive to digital data signals, providing an inkjet receiver suitable for receiving pigmented inks, providing an ink composition as defined in claim 33 to the inkjet printer and causing the inkjet printer to print according to a desired image.

36. (canceled)

37. A functionalised pigment particle as claimed in claim 23, which comprise a functional group which is an ozone scavenger.

38. A functionalised pigment particle as claimed in claim 23, which comprises a functional group which is an ozone scavenger and wherein the ozone scavenging functional group comprises at least one ligand and an ozone-reactive metal ion wherein the ozone-reactive metal ion is selected from the ions of metals in the group consisting of manganese, iron, zinc, aluminium and titanium.
